(19) United States
(12) Patent Application Publication
(10) Pub. No.: US 2025/0171652 A1
(43) Pub. Date: May 29, 2025

(54) METHOD OF MAKING A CATALYST INK AND CONTINUOUS CATALYST INK MIXING SYSTEM

(71) Applicant: UOP LLC, Des Plaines, IL (US)

(72) Inventors: Alexander T. Bridge, Highland Park, IL (US); Hunter D. Smith, Chicago, IL (US); Xueliang Dong, Schaumburg, IL (US); Chunqing Liu, Arlington Heights, IL (US)

(21) Appl. No.: 18/776,412

(22) Filed: Jul. 18, 2024

Related U.S. Application Data
(60) Provisional application No. 63/602,999, filed on Nov. 27, 2023.

(51) Int. Cl. C09D 11/52; C25B 9/23; C25B 11/051

(52) U.S. Cl. CPC C09D 11/52; C25B 9/23; C25B 11/051

(57) ABSTRACT

Methods of continuously dispersing catalyst inks for use in coating processes are described. The catalyst ink is continuously mixed in a high shear mixing unit, and the mixed ink is sonicated in a sonication unit. Part of the sonicated catalyst ink is returned to the high shear mixing unit. The method provides continuous mixing and sonicating of the catalyst ink. The mixed and sonicated ink can then be applied to a substrate in a defined pattern.

### RELATED APPLICATIONS

This application claims priority to U.S. Provisional Patent Application Ser. No. 63/602,999, filed on Nov. 27, 2023, the entirety of which is incorporated herein by reference.

### BACKGROUND

Catalyst coated membranes (CCMs) are a key component for proton exchange membrane (PEM) water electrolyzers and anion exchange membrane (AEM) water electrolyzers with strong commercial potential for green hydrogen generation using renewable energy. Presently, catalyst coated proton exchange membranes (PEM CCMs) represent the most mature CCM candidate for commercialization. However, the best-performing PEM CCMs require platinum group metal (PGM) catalysts for water splitting and hydrogen evolution, which significantly increases the cost for both the CCM manufacturer and the customer.

The term “platinum group metals” (PGMs) means the six noble, precious metallic elements including ruthenium (Ru), rhodium (Rh), palladiunm (Pd), osmium (Os), iridiui (Ir), and platinum (Pt). Typically, unsupported or supported iridium (Ir) based PGM electrocatalysts are used for the oxygen evolution reaction (OER) on the anode and platinum (Pt) or carbon supported platinum electrocatalyst (Pt/C) is used for the hydrogen evolution reaction (HER) on the cathode for PEM water electrolysis. Both Ir and Pt based PGM catalysts are very expensive and scarce.

Furthermore, a lack of active area standardization in lab- and commercial-scale CCMs for water electrolyzers requires CCM manufacturers to constantly adapt coating sizes to different customer requirements. As an added challenge, electrolyzer original equipment manufacturers (OEMs) often require dimensionally stable catalyst coatings that occupy precisely defined active areas. Under-sizing catalyst coatings relative to the target active area will limit CCM productivity, while over-sizing will waste PGM catalyst and interfere with the membrane electrode assembly (MEA) cell's gasket seal.

Slot die patch coating is a powerful and flexible technique for manufacturing large volumes of CCM samples with user-defined geometries for different customers. Because slot dies rely on precise volumetric deposition instead of shearing or fluid transfer (e.g., knife coating, gravure coating, dip coating, or rod coating) to achieve a desired wet layer thickness, this technology is sensitive to fluid viscosity. For example, control over minimum wet thickness has an inverse relationship with viscosity, i.e., thinner slot die coatings (e.g., less than 15 μm) require more viscous fluids, and vice versa. Furthermore, patch coating applications typically involve partial or complete inversion of the slot die (i.e., coating against gravity) to enable clean breaks between coated patches. The non-horizontal path required of the coated substrate can enable undesired migration of coated material prior to drying, which negatively impacts patch dimensional stability.

PGM catalyst inks for PEM anode and cathode coatings are generally prepared with low viscosities (e.g., less than 100 cP) as necessary to achieve desired overall CCM dry thickness and performance. As PGM catalyst inks are suspensions, solids agglomeration and settling will occur over the timescales required for coating equipment setup and operation unless measures are taken to actively maintain catalyst dispersion.

Therefore, there is a need for methods of dispersing catalyst inks, and methods of applying the catalyst inks in defined geometries.

### BRIEF DESCRIPTION OF THE DRAWINGS

FIG. 1 is an illustration of a continuous circulation-based ink preparation apparatus comprising a high shear mixing unit and a sonication unit.

FIG. 2 is an illustration of a slot die coating system comprising a high shear ink mixing unit, two ink sonication units, and a slot die ink applicator close to the coating substrate.

FIG. 3 is a cross-section schematic of a slot die applicator.

### DESCRIPTION

The present invention meets these needs by providing methods of continuously dispersing catalyst inks for use in catalyst coating processes. The catalyst ink is continuously mixed in a high shear mixing unit, and the mixed ink is sonicated in a sonication unit. Part of the sonicated catalyst ink is returned to the high shear mixing unit. This provides continuous mixing and sonicating of the catalyst ink. The mixed and sonicated catalyst ink comprises evenly distributed catalysts, ionomers, solvents and sometimes additives. The mixed and sonicated catalyst ink has solid agglomerates less than 150 μm in effective diameter and less than 5 wt % of catalyst precipitation at the bottom of the high shear mixing unit.

The mixed and sonicated ink can then be applied to a substrate in a defined pattern.

In some embodiments, the catalyst ink comprises a catalyst, an ionomer, a solvent, and optionally an additive. The continuous mixing and sonicating of the catalyst ink before and/or during the process of coating the ink on the substrate can prevent the precipitation of the catalyst particles at the bottom of the ink, which can result in uneven catalyst coating and uneven catalyst loading (mg catalyst/cm² coated membrane) on the membrane.

Any suitable catalyst can be used. Suitable catalysts include, but are not limited to, a platinum group metal (PGM), a PGM supported on a different PGM support, a PGM supported on a non-PGM support, tin, tungsten, cerium, vanadium, cobalt, silver, gold, copper, nickel, molybdenum, iron, chromium, an alloy thereof, an oxide thereof, a carbide thereof, a phosphide thereof, or combinations thereof. In some embodiments, the catalyst includes iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof.

Any suitable ionomers can be used. Suitable ionomers include, but are not limited to, proton-conductive fluorinated or non-fluorinated polymeric ionomers, or a hydroxide-conductive polymeric ionomers, or combinations thereof.

Suitable proton-conductive fluorinated or non-fluorinated polymeric ionomers include, but are not limited to, a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof.

Any suitable solvent can be used. Suitable solvents include, but are not limited to, water, alcohol, acetone, methyl ethyl ketone, ether, tetrahydrofuran, 1,3-dioxolane, methyl acetate, ethyl acetate, dimethyl sulfoxide, dimethylacetamide, dimethylformamide, or combinations thereof.

Any suitable additive can be used. Suitable additives include, but are not limited to, electron conductive polymers. Suitable additives also include, but are not limited to, CeO₂, Ce(OH)₄, CeO₂/ZrO₂, Ce(OH)₄/ZrO₂, or mixtures thereof.

In some embodiments, the method further comprises cooling the high shear mixing unit and the sonication unit.

In some embodiments, the method further comprises controlling the temperature of the continuously mixed catalyst ink and the sonicated catalyst ink using the coolant.

In some embodiments, the temperature of the continuously mixed catalyst ink and the sonicated catalyst ink is controlled to a range of about 0° C. to about 20° C.

In some embodiments, sonicating the continuously mixed catalyst ink comprises passing the continuously mixed catalyst ink around the sonication probe.

In some embodiments, the method further comprises: passing a second portion of the sonicated catalyst ink to a coating system comprising an applicator; and applying the sonicated catalyst ink to a substrate to form a uniform catalyst ink coating on the substrate.

In some embodiments, the substrate is a membrane and the uniform catalyst ink coating on the substrate forms a catalyst coated membrane.

In some embodiments, the applicator comprises a slot die applicator, a spray coating applicator, a Mayer rod applicator, a casting knife applicator, or combinations thereof.

In some embodiments, the applicator is a slot die applicator.

In some embodiments, the method further comprises drying the catalyst ink coating to from a catalyst coated substrate.

In some embodiments, the method further comprises cooling the applicator and controlling the temperature of the sonicated catalyst ink.

When executed correctly, slot die patch coating can meet the various CCM active area requirements for different electrolyzers. Slot die patch coating also carries advantages over other types of patterned coating in that the tooling is inexpensive and modular. This enables a PEM CCM manufacturer to switch between different customers' products relatively quickly. To reproducibly manufacture patch coated CCMs with strict dimensional and performance tolerances, ink catalyst dispersion and fluid behavior must be actively controlled during coating. Thus, several measures specific to CCM PGM catalyst inks have been developed to address their fluid behavior during coating. Any or all of these measures could be used to improve coating quality in patch and continuous catalyst coatings.

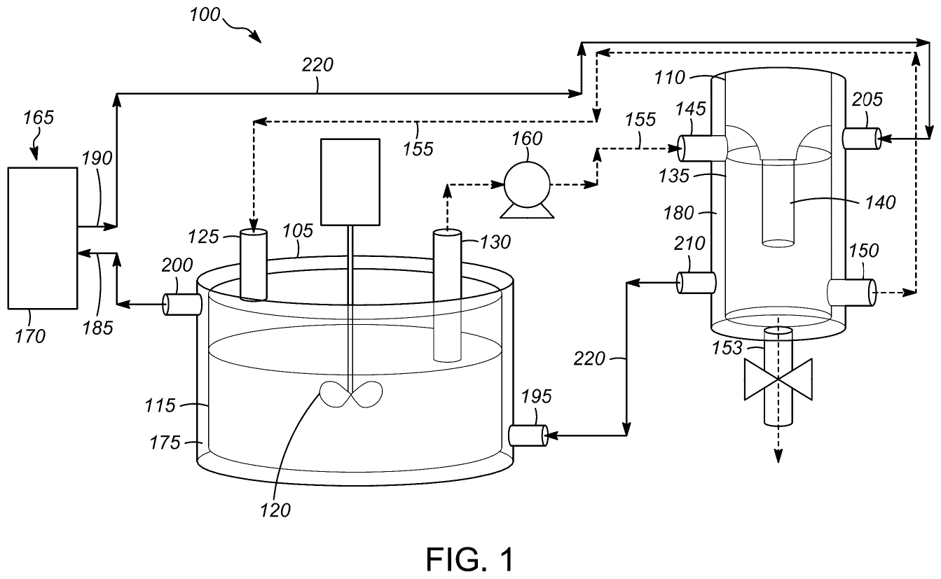

To obtain ink homogeneity prior to coating, a circulation-based ink preparation apparatus with temperature control was designed to constantly agitate and disperse the ink components to form evenly distributed catalysts, ionomers, solvents and sometimes additives with less than 5% of catalyst precipitation. As shown in FIG. 1, the apparatus comprises a high shear mixing unit and a sonication unit. The high shear mixing unit comprises a vessel and a high shear mixer impeller. The high shear mixing unit has high rotor tip speeds (e.g., ranging from about 10 to about 50 m/s), high shear rates (e.g., ranging from about 2,000 to about 10,000 rpm), highly localized energy dissipation rates near the mixing head, and relatively higher power consumption compared with conventional mechanically stirred mixing units (See Zhang et al., Chemical Engineering and Processing, 57-58 (2012) 25-41).

The apparatus may utilize a jacketed vessel with a multi-port extraction lid for ink storage and circulation in cases where cooling the catalyst ink is desired to obtain a specific viscosity, for example, when the catalyst ink has a viscosity less than about 100 cPs and a higher viscosity is desired for application of the catalyst ink to the substrate. Coolant is circulated through the vessel jacket to maintain the ink temperature at a desired setpoint. The desired setpoint can be a specific temperature or a desired temperature range, e.g., about 0-20° C. The sonication unit may be similarly jacketed. Insulation may be used on all ink tubing to minimize the influence of ambient conditions on system-wide ink temperature.

The ink is constantly agitated via a high shear mixer impeller inserted through the extraction lid's central port to prevent catalyst settling. Ink extraction and return lines connected to the lid's outer ports, coupled with an optional pump, permit constant circulation of the catalyst ink between the high shear mixing unit and the sonication unit.

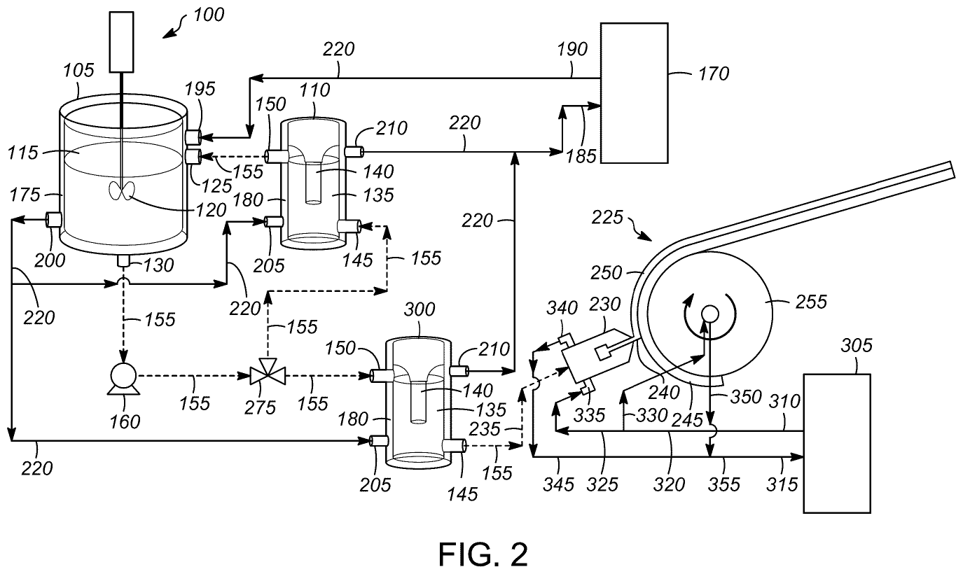

The sonication unit comprises a chamber and a continuous sonication probe. The sonication probe is encapsulated in a chamber that enables circulating ink to constantly flow past the probe and return to the original vessel of the high shear mixing unit. As discussed above, the chamber may be jacketed and connected in series with the cooling lines from the vessel of the high shear mixing unit to ensure uniform temperature control throughout the entire ink mixing system. Depending on the catalyst ink being prepared, chilling to about 0-20° C. may be applied to the vessel of the high shear mixing unit and the chamber for the sonication unit to increase ink viscosity for coating. This entire circulation-based ink preparation system may be standalone, as presented in FIG. 1, or integrated within a coating system, as exemplified for a slot die applicator in FIG. 2.

After the initial ink mixing and dispersion is completed in a standalone ink preparation system (cf. FIG. 1), a drain line at the bottom of the continuous sonication probe chamber is opened with the pump running to divert ink flow into the ink vessel of the coating system comprising an applicator. The ink vessel, along with the coating applicator, may also be chilled to about 0-20° C. Additionally, a second mixer may be integrated into the ink vessel lid of the coating system to provide constant agitation during coating to minimize catalyst settling. The second mixer may be a high shear mixer. If the ink preparation equipment is integrated within the coating system (cf. FIG. 2), no draining of ink and transfer to a secondary vessel and mixer occurs. Instead, the position of a three-way diverter valve is switched such that ink flow is directed to the applicator for coating (i.e., the valve's default position returns ink to the stirred vessel through a continuous sonicator).

During coating, regardless of the ink preparation system used, the catalyst ink is delivered to the applicator via a gear pump, a peristaltic pump, a progressive cavity pump, or a diaphragm pump, for example. Additionally, the ink delivery line may feed through a continuous sonicator probe placed upstream of the applicator inlet as shown in FIG. 2. In this way, catalyst ink solids will be dispersed immediately prior to entering the applicator.

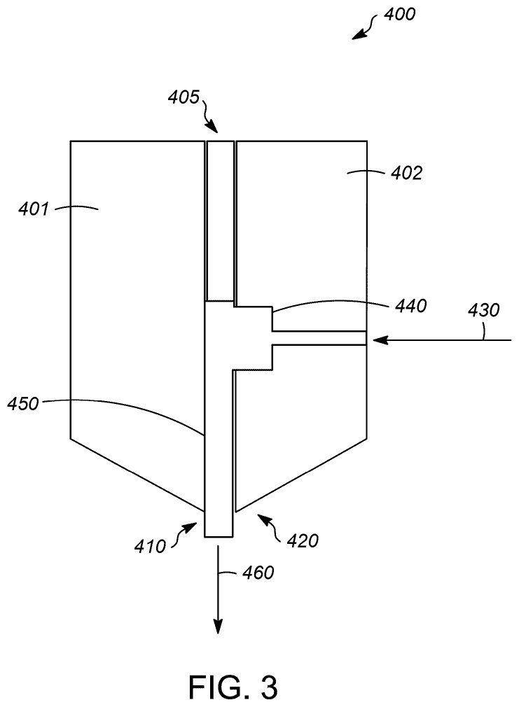

When the applicator is a slot die, the opening of the slot die may also be restricted to maximize pressure drop, and, by extension, catalyst ink back pressure to ensure even ink distribution across the width of the coating and control the patch coating process. Thus, thin (e.g, 1-3 mil) shims are used to set the slot die opening thickness as shown in FIG. 3. Inverted patch coating is performed on a 0-20° C. chilled backing roller to limit ink flowback down the substrate prior to drying. The ink pump rate, slot die web gap, and line speed are adjusted to achieve the desired catalyst layer thickness and minimize pre-drying time while maintaining an acceptable oven residence time. Catalyst ink pullback into the slot die lips with a diaphragm, and, if necessary, slot die movement may also be used to ensure clean breaks at the patch lagging ends.

As shown in FIG. 1, the continuous catalyst ink mixing apparatus 100 comprises a high shear mixing unit 105 and a sonication unit 110. The high shear mixing unit 105 comprises a vessel 115 and a high shear impeller 120. The vessel 115 has an ink inlet 125 and an ink outlet 130. The sonication unit 110 comprises a chamber 135 and a sonication probe 140. The chamber 135 has an ink inlet 145, a first ink outlet 150, and a second ink outlet 153.

The ink inlet 145 of the sonication unit 110 is in downstream fluid communication with the ink outlet 130 of the high shear mixing unit 105, and the ink inlet 125 of the high shear mixing unit 105 is in downstream fluid communication with the first ink outlet 150 of the sonication unit 110. This creates an ink circulation circuit 155 between the high shear mixing unit 105 and the sonication unit 110 in which the catalyst ink is continuously mixed and sonicated.

There can be a pump 160 on the ink circulation circuit 155. The pump can be positioned at any suitable location in the ink circulation circuit 155, such as between the high shear mixing unit 105 and the sonication unit 110. Any suitable type of pump can be used, including but not limited to, peristaltic pumps, gear pumps, diaphragm pumps, progressive cavity pumps, or combinations thereof.

The continuous catalyst ink mixing apparatus 100 may include a cooling system 165 to maintain a desired temperature of the catalyst ink. The cooling system 165 comprises a coolant circulator 170, a coolant jacket 175 on the vessel 115 of the high shear mixing unit 105, and a coolant jacket 180 on the chamber 135 of the sonication unit 110. The coolant circulator 170 has a coolant inlet 185 and a coolant outlet 190. The coolant jacket 175 on the vessel 115 of the high shear mixing unit 105 has a coolant inlet 195 and a coolant outlet 200. The coolant jacket 180 on the chamber 135 of the sonication unit 110 has a coolant inlet 205 and a coolant outlet 210. The coolant inlet 205 of the sonication unit 110 is in downstream fluid communication with the coolant outlet 190 of the coolant circulator 170. The coolant inlet 195 of the high shear mixing unit 105 is in downstream fluid communication with the coolant outlet 210 of the sonication unit 110. The coolant inlet 185 of the coolant circulator 170 is in downstream fluid communication with the coolant outlet 200 of the high shear mixing unit 105. This forms a coolant circuit 220.

As shown in FIG. 2, the apparatus may include a coating system 225 comprising a coating applicator 230, a second continuous sonicator 300, and a second coolant circulator 305. The ink mixing apparatus 100, in this configuration, is separated from the coating system 225 by a three-way diverter valve 275. The diverter valve 275 default position for ink mixing directs ink flow back to the high shear mixing unit 105 through the first continuous sonicator 110, consistent with the system depicted in FIG. 1. For coating, the diverter valve 275 position is switched such that ink is sent to the coating applicator 230 through the second continuous sonicator 300. This diverter valve 275 action functionally replaces the drain valve 153 depicted in FIG. 1. The second sonicator 300 ensures the PGM catalyst is uniformly dispersed immediately prior to coating. The coating applicator 230 has an ink inlet 235 and an ink outlet 240. The ink inlet 235 of the coating applicator 230 is in downstream fluid communication with the first ink outlet of the second sonication unit 300. The ink flows through out of the ink outlet 240 of the coating applicator 230 onto the surface of substrate 245 and forms a coating layer 250 on the substrate 245. The substrate 245 is supported by a backing roller 255. The coating applicator 230 and backing roller 255 can be included in the coolant circuit 220 to maintain the desired temperature of the catalyst ink if needed.

Alternatively, as shown in FIG. 2, a separate cooling circulator 305 with a coolant outlet 310 and coolant inlet 315 can be used. The coolant stream 320 from the outlet 310 is split into coolant stream 325 and coolant stream 330. The coolant stream 325 flows to the coating applicator 230 through inlet 335, and coolant stream 345 exits through outlet 340. Coolant stream 330 flows to the backing roller 255, and coolant stream 350 exits from the backing roller 255, Coolant streams 345 and 350 are combined in coolant stream 355 which returns to the coolant circulator through coolant inlet 315.

FIG. 3 shows a cross-section schematic of a slot die applicator 400 comprises two parts 401 and 402 that are bolted together, shims 405 that are bolted between 401 and 402 and used to set the slot die opening thickness, slot die lips 410 and 420, ink inlet 430, ink reservoir 440, ink flow channel 450, and ink outlet 460. The slot die applicator 400 is used to provide a uniform delivery of a uniformly dispersed catalyst ink to the coating substrate and determines controlled distribution of the catalyst ink across the width of the coating.

### SPECIFIC EMBODIMENTS

While the following is described in conjunction with specific embodiments, it will be understood that this description is intended to illustrate and not limit the scope of the preceding description and the appended claims.

A first embodiment of the invention is a method of continuously dispersing a catalyst ink for coating comprising continuously mixing a catalyst ink at high shear in a high shear mixing unit; passing the continuously mixed catalyst ink to a sonication unit; sonicating the continuously mixed catalyst ink; passing a first portion of the sonicated catalyst ink to the high shear mixing unit. An embodiment of the invention is one, any or all of prior embodiments in this paragraph up through the first embodiment in this paragraph wherein the catalyst ink comprises a catalyst, an ionomer, a solvent, and optionally an additive. An embodiment of the invention is one, any or all of prior embodiments in this paragraph up through the first embodiment in this paragraph wherein the catalyst comprises a platinum group metal (PGM), a PGM supported on a different PGM support, a PGM supported on a non-PGM support, tin, tungsten, cerium, vanadium, cobalt, silver, gold, copper, nickel, molybdenum, iron, chromium, an alloy thereof, an oxide thereof, a carbide thereof, a phosphide thereof, or combinations thereof. An embodiment of the invention is one, any or all of prior embodiments in this paragraph up through the first embodiment in this paragraph wherein the ionomer comprises a proton-conductive fluorinated or non-fluorinated polymeric ionomer or a hydroxide-conductive polymeric ionomer, or combinations thereof. An embodiment of the invention is one, any or all of prior embodiments in this paragraph up through the first embodiment in this paragraph wherein the solvent comprises water, alcohol, acetone, methyl ethyl ketone, ether, tetrahydrofuran, 1,3-dioxolane, methyl acetate, ethyl acetate, dimethyl sulfoxide, dimethylacetamide, dimethylformamide, or combinations thereof. An embodiment of the invention is one, any or all of prior embodiments in this paragraph up through the first embodiment in this paragraph wherein the additive comprises an electron conductive polymer. An embodiment of the invention is one, any or all of prior embodiments in this paragraph up through the first embodiment in this paragraph wherein the additive comprises CeO₂, Ce(OH)₄, CeO₂/ZrO₂, Ce(OH)₄/ZrO₂, or mixtures thereof. An embodiment of the invention is one, any or all of prior embodiments in this paragraph up through the first embodiment in this paragraph further comprising cooling the high shear mixing unit and the sonication unit. An embodiment of the invention is one, any or all of prior embodiments in this paragraph up through the first embodiment in this paragraph further comprising controlling a temperature of the continuously mixed catalyst ink and the sonicated catalyst ink using the coolant. An embodiment of the invention is one, any or all of prior embodiments in this paragraph up through the first embodiment in this paragraph wherein the temperature of the continuously mixed catalyst ink and the sonicated catalyst ink is controlled to a range of about 0° C. to about 20° C. An embodiment of the invention is one, any or all of prior embodiments in this paragraph up through the first embodiment in this paragraph wherein sonicating the continuously mixed catalyst ink comprises passing the continuously mixed catalyst ink around the sonication probe. An embodiment of the invention is one, any or all of prior embodiments in this paragraph up through the first embodiment in this paragraph further comprising passing a second portion of the sonicated catalyst ink to a coating system comprising an applicator; applying the sonicated catalyst ink to a substrate to form a uniform catalyst ink coating on the substrate. An embodiment of the invention is one, any or all of prior embodiments in this paragraph up through the first embodiment in this paragraph wherein the substrate is a membrane and the uniform catalyst ink coating on the substrate forms a catalyst coated membrane. An embodiment of the invention is one, any or all of prior embodiments in this paragraph up through the first embodiment in this paragraph further comprising drying the catalyst ink coating to from a catalyst coated substrate. An embodiment of the invention is one, any or all of prior embodiments in this paragraph up through the first embodiment in this paragraph further comprising cooling the applicator and controlling the temperature of the sonicated catalyst ink.

A second embodiment of the invention is a continuous catalyst ink mixing apparatus for uniform catalyst coating comprising a high shear mixing unit comprising a vessel and a high shear impeller, the vessel having an ink inlet and an ink outlet; a sonication unit comprising a chamber and a sonication probe, the sonication unit having an ink inlet, a first ink outlet, and a second ink outlet, the ink inlet of the sonication unit being in downstream fluid communication with the ink outlet of the high shear mixing unit, and the ink inlet of high shear mixing unit being in downstream fluid communication with the first ink outlet of the sonication unit forming an ink circulation circuit. An embodiment of the invention is one, any or all of prior embodiments in this paragraph up through the second embodiment in this paragraph further comprising a pump positioned between the ink outlet of the high shear mixing unit and the ink inlet of the sonication unit in the ink circulation circuit. An embodiment of the invention is one, any or all of prior embodiments in this paragraph up through the second embodiment in this paragraph further comprising a coolant system comprising a coolant tank having a coolant inlet and a coolant outlet; a coolant jacket on the high shear mixing unit having a coolant inlet and a coolant outlet; a coolant jacket on the sonication unit having a coolant inlet and a coolant outlet, the coolant inlet of the sonication unit being in downstream fluid communication with the coolant outlet of the coolant tank, the coolant inlet of the high shear mixing unit being in downstream fluid communication with the coolant outlet of the sonication unit, and the coolant inlet of the coolant tank being in downstream fluid communication with the coolant outlet of the high shear mixing unit forming a coolant circuit. An embodiment of the invention is one, any or all of prior embodiments in this paragraph up through the second embodiment in this paragraph further comprising a coating system comprising a coating applicator having an ink inlet and an ink outlet, the ink inlet of the coating applicator being in downstream fluid communication with the second ink outlet of the sonication unit, and the ink outlet of the coating applicator capable of applying a uniform catalyst ink coating to a substrate.

A third embodiment of the invention is a catalysts ink with less than 5 wt % of catalyst precipitation prepared by a method comprising continuously mixing a catalyst ink at high shear in a high shear mixing unit; passing the continuously mixed catalyst ink to a sonication unit; sonicating the continuously mixed catalyst ink; passing a first portion of the sonicated catalyst ink to the high shear mixing unit; wherein the catalyst ink comprises a catalyst, an ionomer, a solvent, and optionally an additive, and wherein the mixed and sonicated catalyst ink comprises evenly distributed catalysts, ionomers, solvents and optionally additives. The mixed and sonicated catalyst ink has solid agglomerates less than 150 μm in effective diameter and less than 5 wt % of catalyst precipitation at the bottom of the high shear mixing unit.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of continuously dispersing a catalyst ink for coating comprising:
continuously mixing a catalyst ink at high shear in a high shear mixing unit;
passing the continuously mixed catalyst ink to a sonication unit;
sonicating the continuously mixed catalyst ink; and
passing a first portion of the sonicated catalyst ink to the high shear mixing unit.

2. The method of claim 1 wherein the catalyst ink comprises a catalyst, an ionomer, a solvent, and optionally an additive.

3. The method of claim 2 wherein the catalyst comprises a platinum group metal (PGM), a PGM supported on a different PGM support, a PGM supported on a non-PGM support, tin, tungsten, cerium, vanadium, cobalt, silver, gold, copper, nickel, molybdenumr, iron, chromium, an alloy thereof, an oxide thereof, a carbide thereof, a phosphide thereof, or combinations thereof.

4. The method of claim 2 wherein the ionomer comprises a proton-conductive fluorinated or non-fluorinated polymeric ionomer or a hydroxide-conductive polymeric ionomer, or combinations thereof.

5. The method of claim 2 wherein the solvent comprises water, alcohol, acetone, methyl ethyl ketone, ether, tetrahydrofuran, 1,3-dioxolane, methyl acetate, ethyl acetate, dimethyl sulfoxide, dimethylacetamide, dimethylformamide, or combinations thereof.

6. The method of claim 2 wherein the additive comprises an electron conductive polymer.

7. The method of claim 2 wherein the additive comprises CeO₂, Ce(OH)₄, CeO₂/ZrO₂, Ce(OH)₄/ZrO₂, or mixtures thereof.

8. The method of claim 1 further comprising:
cooling the high shear mixing unit and the sonication unit.

9. The method of claim 8 further comprising:
controlling a temperature of the continuously mixed catalyst ink and the sonicated catalyst ink using the coolant.

10. The method of claim 9 wherein the temperature of the continuously mixed catalyst ink and the sonicated catalyst ink is controlled to a range of about 0° C. to about 20° C.

11. The method of claim 1 wherein sonicating the continuously mixed catalyst ink comprises passing the continuously mixed catalyst ink around the sonication probe.

12. The method of claim 1 further comprising:
passing a second portion of the sonicated catalyst ink to a coating system comprising an applicator; and
applying the sonicated catalyst ink to a substrate to form a uniform catalyst ink coating on the substrate.

13. The method of claim 12 wherein the substrate is a membrane and the uniform catalyst ink coating on the substrate forms a catalyst coated membrane.

14. The method of claim 12 further comprising:
drying the catalyst ink coating to from a catalyst coated substrate.

15. The method of claim 12 further comprising:
cooling the applicator and controlling the temperature of the sonicated catalyst ink.

16. A continuous catalyst ink mixing apparatus for uniform catalyst coating comprising:
a high shear mixing unit comprising a vessel and a high shear impeller, the vessel having an ink inlet and an ink outlet; and
a sonication unit comprising a chamber and a sonication probe, the sonication unit having an ink inlet, a first ink outlet, and a second ink outlet, the ink inlet of the sonication unit being in downstream fluid communication with the ink outlet of the high shear mixing unit, and the ink inlet of high shear mixing unit being in downstream fluid communication with the first ink outlet of the sonication unit forming an ink circulation circuit.

17. The apparatus of claim 16 further comprising:
a pump positioned between the ink outlet of the high shear mixing unit and the ink inlet of the sonication unit in the ink circulation circuit.

18. The apparatus of claim 16 further comprising:
a coolant system comprising:
a coolant tank having a coolant inlet and a coolant outlet;
a coolant jacket on the high shear mixing unit having a coolant inlet and a coolant outlet; and
a coolant jacket on the sonication unit having a coolant inlet and a coolant outlet, the coolant inlet of the sonication unit being in downstream fluid communication with the coolant outlet of the coolant tank, the coolant inlet of the high shear mixing unit being in downstream fluid communication with the coolant outlet of the sonication unit, and the coolant inlet of the coolant tank being in downstream fluid communication with the coolant outlet of the high shear mixing unit forming a coolant circuit.

19. The apparatus of claim 16 further comprising:
a coating system comprising a coating applicator having an ink inlet and an ink outlet, the ink inlet of the coating applicator being in downstream fluid communication with the second ink outlet of the sonication unit, and the ink outlet of the coating applicator capable of applying a uniform catalyst ink coating to a substrate.

20. A catalyst ink with less than 5 wt % of catalyst precipitation prepared by a method comprising:
continuously mixing a catalyst ink at high shear in a high shear mixing unit;
passing the continuously mixed catalyst ink to a sonication unit;
sonicating the continuously mixed catalyst ink;
passing a first portion of the sonicated catalyst ink to the high shear mixing unit; and
wherein the catalyst ink comprises a catalyst, an ionomer, a solvent, and optionally an additive, and wherein the mixed and sonicated catalyst ink comprises evenly distributed catalysts, ionomers, solvents, and optionally additives, the catalyst ink having solid agglomerates less than 150 μm in effective diameter and less than 5 wt % of catalyst precipitation at the bottom of the high shear mixing unit.
